(19) United States
(12) Patent Application Publication
(10) Pub. No.: US 2013/0280008 A1
(43) Pub. Date: Oct. 24, 2013

(54) Bolted joint of the cover of an access opening in an aircraft lifting surface

(71) Applicant: AIRBUS OPERATIONS S.L., Getafe (ES)

(72) Inventors: Jose Sanz Torrijos, Getafe (ES); Marcos Alazarki, Getafe (ES)

(73) Assignee: AIRBUS OPERATIONS S.L., Getafe (ES)

(21) Appl. No.: 13/845,272

(22) Filed: Mar. 18, 2013

(30) Foreign Application Priority Data
Apr. 18, 2012 (EP) 12382152.2

(51) Int. Cl. B64C 3/26

(52) U.S. Cl. CPC B64C 3/26
USPC 411/337; 411/378

(57) ABSTRACT

A bolted joint for connecting a cover of an opening in a primary structure of a lifting surface of an aircraft to the primary structure. The bolted joint includes two first bolted joints on either side of a symmetry axis of the cover arranged without any lateral clearance, two second bolted joints on either side of the symmetry axis on the side of the cover opposite to that of the two first bolted joints, arranged without any lateral clearance in the holes of the primary structure and with a linear lateral clearance in the holes of the cover; a plurality of third bolted joints along the border of the cover arranged without any lateral clearance in the holes of the primary structure and with a radial clearance in the holes of the cover.

### CROSS-REFERENCES TO RELATED APPLICATIONS

This application claims the benefit of the European patent application No. 12382152.2 filed on Apr. 18, 2012, the entire disclosures of which are incorporated herein by way of reference.

### BACKGROUND OF THE INVENTION

The present invention relates to lifting surfaces of aircraft and, more particularly, to a bolted joint of the cover of an access opening in an aircraft lifting surface such as the cover of a fuel tank access opening in the lower wing skin of an aircraft.

The design of the cover of the access opening of a fuel tank which is mounted in the wing of an aircraft shall, at least, meet the following requirements:
Provide a reliable seal to prevent leakage from the fuel tank.
Facilitate its removal for maintenance purposes.
Have a low weight.
Have an adequate structural strength.

As the wing of the aircraft deflects upwardly and downwardly under aerodynamic loads, the lower skin of the wing where the access opening to the fuel tank is located and its cover are subjected to deflections that affect the design of the attachment of the cover to the skin of the wing.

FIG. 1 schematically shows the cover 11 of a fuel tank access opening which is joined to the lower skin 13 of the wing by means of bolted joints 12 according to the prior art and FIG. 2 shows a cross section of one bolted joint 12.

The cover 11 has a symmetry axis A-A in the direction of the span of the wing substantially parallel to the reinforcing stringers 15, 15′ of the lower skin 13 of the wing.

As can be seen in FIG. 2, there is a hole clearance between a bushing 14 joined to the lower skin 13 and the bolt 31, whereas the cover 11 has a countersunk hole with no hole clearances. This means that the cover 11 moves with the bolt 31 (to which it is fixed) with respect to the lower skin 13.

Ideally the cover 11 should not support loads. For this to happen, the bolts 31 of the joints 12 must not contact the bushings 14 of the lower skin 13. Otherwise, loads would be transmitted from the lower skin 13 to the cover 11.

Due to the bending moments supported by the wings, the bolts 31 can enter into contact with the bushings 14 of the lower skin 13, thus cancelling the hole clearance of the joints 12 on one side. When the hole clearance of a joint 12 is cancelled on one side, the cover 11 starts to take loads. This is illustrated in FIG. 3: when a bolt 31 is floating inside the hole in a bushing 14 of the lower skin 13, the loads L transmitted from the lower skin 13 to the cover 11 are insignificant, but as soon as the bolt 31 touches the bushing 14 of the lower skin 13 on one side, the loads L transmitted from the lower skin 13 to the cover 11 increase dramatically. Consequently, the cover 11 has to be reinforced, with a corresponding increase in weight due to the fact that it does end up carrying loads.

### SUMMARY OF THE INVENTION

It is an object of the present invention to provide a bolted joint between a primary structure of an aircraft lifting surface (such as a skin of an aircraft wing) and a secondary structure (such as a cover of an opening in the skin of the aircraft wing) that avoids the transmission of loads from the primary structure to the secondary structure.

It is another object of the present invention to provide a bolted joint between a primary structure of an aircraft lifting surface (such as a skin of an aircraft wing) and a secondary structure (such as a cover of an opening in the skin of the aircraft wing) that allows reducing the weight of the secondary structure.

These and another objects are met by a bolted joint for connecting a cover of an opening in a primary structure of a lifting surface of an aircraft to said primary structure, the cover having a symmetry axis A-A in the direction of the span of said lifting surface comprising
two first bolted joints on either side of the symmetry axis A-A on the side of the cover closest to the root of the lifting surface, or on the side of the cover farthest from the root of the lifting surface, arranged without any clearance in the holes of the primary structure and in the holes of the cover;
two second bolted joints on either side of the symmetry axis A-A on the side of the cover opposite to that of the two first bolted joints, arranged without any clearance in the holes of the primary structure and with a clearance in the holes of the cover in the direction of said symmetry axis A-A;
a plurality of third bolted joints along the border of the cover arranged without any clearance in the holes of the primary structure and with a radial clearance in the holes of the cover.

In one embodiment the first, second and third bolted joints comprise a bolt with a bushing fixed to it having the same length L as a thickness W of the cover.

Advantageously the hole in the cover and the bushing in the second bolted joints are configured, respectively, with frontal facing surfaces having a frontal clearance Cf between them and with lateral facing surfaces having a linear clearance Cx between them in the direction of said symmetry axis A-A.

Advantageously the hole in the cover and the bushing in the third bolted joints are configured, respectively, with frontal facing surfaces having a frontal clearance Cf between them and with lateral facing surfaces having a radial clearance Cx between them.

Other desirable features and advantages of the bolted joint according to this invention will become apparent from the subsequent detailed description of the invention and the appended claims, in relation with the enclosed drawings.

### BRIEF DESCRIPTION OF THE DRAWINGS

FIG. 1 is a plan view of a cover of a fuel tank access opening in a lower skin of the wing of an aircraft according to the prior art.

FIG. 2 is a section view of one of the joints between said cover and said lower skin.

FIG. 3 is a diagram showing the relation between the load L transferred from the lower skin to the cover and the clearance C in the joints shown in FIGS. 1 and 2.

FIG. 4 is a plan view of a cover of a fuel tank access opening in a lower skin of the wing of an aircraft according to the present invention.

FIG. 5 is a section view of one embodiment of a joint between said cover and said lower skin according to the present invention.

FIGS. 6a and 6b are schematic views of joints with linear and radial clearances.

FIG. 7 is a section view of another embodiment of a joint between said cover and said lower skin according to the present invention.

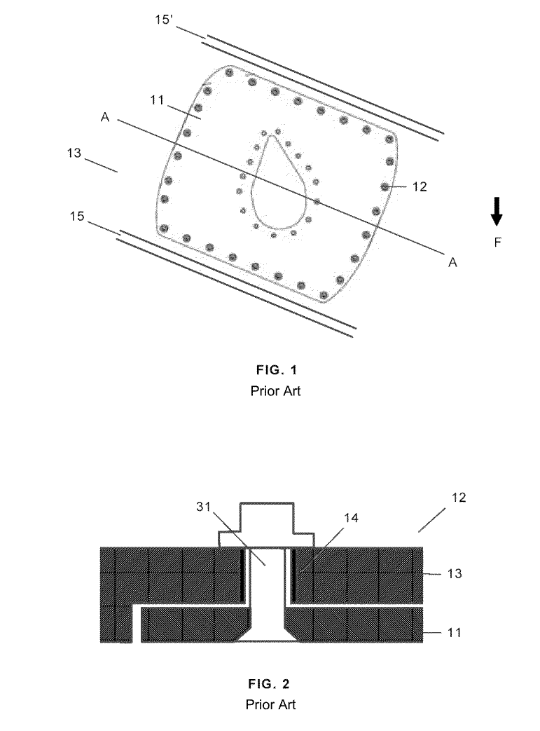

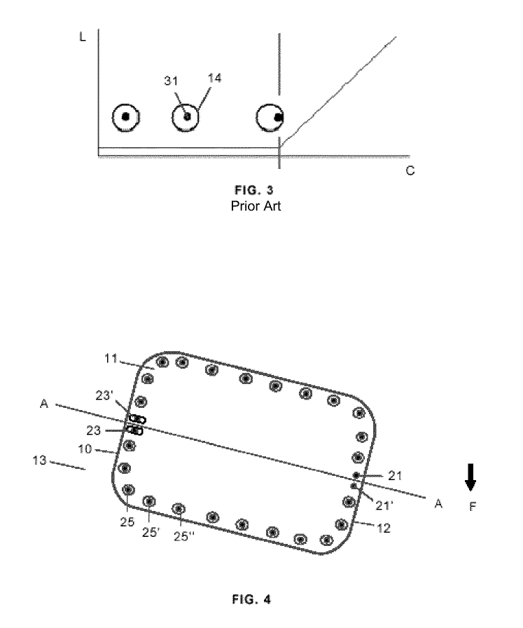

### DETAILED DESCRIPTION OF THE PREFERRED EMBODIMENTS

FIG. 4 illustrates the bolted joint of the cover 11 of a fuel tank access opening in the lower skin 13 of the wing of an aircraft as an example of a bolted joint of a cover of an opening in a primary structure of a lifting surface of an aircraft according to this invention.

The bolted joint comprises
Two first fixed bolted joints 21, 21′ on either side of the axis A-A on the side 12 of the cover 11 farthest from the root of the wing (and closest to the incoming flow F). The axis A-A is the symmetry axis of the cover 11 in the wing span direction. The displacements of the lower skin 13 of the wing due to the aerodynamic loads increase along its span.
Two second bolted joints 23, 23′ on the side 10 of the cover 11 closest to the wing root (and farthest from the incoming flow) without any clearance in the holes of the lower skin 13 and with a lateral clearance in the holes of the cover 11 only in the direction of said symmetry axis A-A.
A plurality of third bolted joints 25, 25′, 25″, . . . on the border of the cover 11 without any lateral clearance in the holes of the lower skin 13 and with a radial lateral clearance in the holes of the cover 11.

The fixed bolted joints 21, 21′ ensure that the cover 11 moves with the lower skin 13 of the wing.

These fixed bolted joints 21, 21′ transmit the loads carried by the lower skin 13 of the wing to the cover 11, but the cover 11 will not carry said loads (and need not be reinforced) unless these loads can be transmitted back to the lower skin 13 through the rest of the bolted joints of the cover 11. In other words, the cover 11 will only carry loads if loads are transmitted from the lower skin 13 to the cover 11 through an entry point and back to the lower skin 13 through an exit point.

In order to avoid this load transfer, the second bolted joints 23, 23′ and the third bolted joints 25, 25′, 25″, . . . have lateral clearances in the holes of the cover 11 avoiding the contact of the bolts 31 with the cover 11.

These clearances must never be cancelled by the displacement of the lower skin 13 of the wing due to the aerodynamic loads. This means that the clearances must have the dimensions needed for more than compensating the maximum displacement of the lower skin 13 with respect to the fixed bolted joints 21, 21′.

The fixed bolted joints 21, 21′ provide a reference point because the cover 11 is able to return to a home position each time due to the second bolted joints 23, 23′, so that the maximum displacements of the cover 11 are limited. Otherwise, the cover 11 could shift in position each time and end at a different home position involving the risk of a situation without a clearance in some of the third bolted joints 25, 25′, 25″.

FIG. 5 illustrates an embodiment of a bolted joint with clearances in the cover 11 according to this invention.

The hole in the lower skin 13 does not have any lateral clearance with respect to the bolt 31.

The bolt 31 has a bushing 33 fixed to it, with a length L of the bushing 33 substantially equal to a thickness W of the cover 11.

The bushing 33 must be light, conduct electricity and avoid corrosion problems. It can be made of one of the following materials: PEEK, Aluminum, stainless steel or Polyphenylene sulphide (PPS).

The hole 30 and the bushing 33 are configured, respectively, with lateral facing surfaces 44, 46; 45, 47 having a lateral clearance Cx between them and with frontal facing surfaces 40, 43 having a frontal clearance Cf between them.

The lateral clearance Cx corresponds to the above mentioned clearances that enable the cover 11 to not take loads from the lower skin 13.

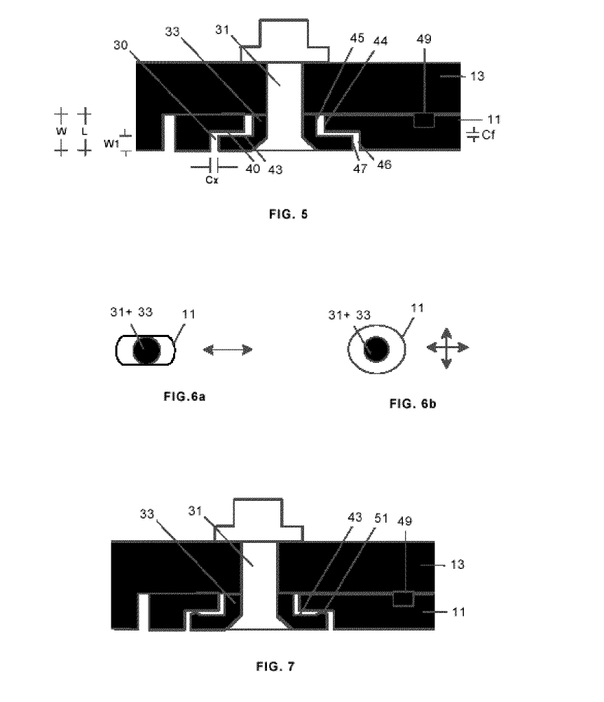

In the case of a second bolted joint 23, 23′ the lateral clearance Cx is a clearance restricted in a linear direction. FIG. 6a schematically shows the clearance between the bolt 31 with the bushing 33 and the cover 11 in these joints allowing one degree of translational freedom.

In the case of a third bolted joint 25, 25′, 25″, the lateral clearance Cx is a radial clearance. FIG. 6b schematically shows the clearance between the bolt 31 with the bushing 33 and the cover 11 in these joints allowing two degrees of translational freedom.

The frontal clearance Cf allows the implementation of a low friction surface between the frontal facing surfaces 43, 40 of the bushing 33 and the cover 11 for facilitating relative horizontal displacements between said surfaces.

Several techniques may be used for implementing said low friction surface, for example attaching a Teflon pad (not shown in FIG. 6) to one of the facing surfaces 43, 40.

In addition, the frontal surface 43 of the bushing 33 may be configured with a rounded protruding edge 51 (see FIG. 7) that provides a contact point between both frontal facing surfaces regardless of the contact angle between them, helping their relative displacements.

As shown in FIGS. 5 and 7, the bolted joints according to this invention also comprise a seal 49 avoiding fuel leaks but allowing relative displacements between the lower skin 13 and the cover 11.

The bolted joint according to this invention provides a reduction of the weight and the cost of the cover and is particularly applicable to a cover and a primary structure made of a composite material.

Although the present invention has been described in connection with various embodiments, it will be appreciated from the specification that various combinations of elements, variations or improvements therein may be made, and are within the scope of the invention.

1. A bolted joint for connecting a cover of an opening in a primary structure of a lifting surface of an aircraft to said primary structure, the cover having a symmetry axis in a direction of a span of said lifting surface, the primary structure and the cover each having a plurality of holes for receiving bolts, comprising:
two first bolted joints on either side of the symmetry axis on one of a side of the cover closest to a root of the lifting surface and a side of the cover farthest from the root of the lifting surface, arranged without any lateral clearance between the bolts and the holes in the primary structure and between the bolts and the holes in the cover;
two second bolted joints on either side of the symmetry axis on the side of the cover opposite to that of the two first bolted joints, arranged without any lateral clearance between the bolts and the holes in the primary structure and with a lateral clearance between the bolts and the holes of the cover in the direction of said symmetry axis;
a plurality of third bolted joints along a border of the cover arranged without any lateral clearance between the bolts and the holes in the primary structure and with a radial clearance between the bolts and the holes in the cover.

2. The bolted joint according to claim 1, wherein each first bolted joint comprises one of the bolts with a bushing fixed to it, the bushing having a length which is the same as a thickness of the cover, and the hole in the cover and the bushing are configured without any lateral clearance between them.

3. The bolted joint according to claim 1, wherein each second bolted joint comprises one of the bolts with a bushing fixed to it, the bushing having a length which is the same as a thickness of the cover, and the hole in the cover and the bushing are configured with a linear clearance between them in the direction of said symmetry axis.

4. The bolted joint according to claim 3, wherein said bushing and said hole are configured, respectively, with frontal facing surfaces having a frontal clearance between them and with lateral facing surfaces having a linear clearance between them in the direction of said symmetry axis.

5. The bolted joint according to claim 1, wherein each third bolted joint comprises one of the bolts with a bushing fixed to it, the bushing having a length which is the same as a thickness of the cover, and the hole in the cover and the bushing are configured with a radial clearance between them.

6. The bolted joint according to claim 5, wherein said bushing and said hole are configured, respectively, with frontal facing surfaces having a frontal clearance between them and with lateral facing surfaces having a radial clearance between them.

7. The bolted joint according to claim 6, wherein the frontal facing surface of the bushing has a rounded protruding edge.

8. The bolted joint according to claim 1, wherein said bushing is made of one of the following materials: PEEK, Aluminum, Stainless Steel, PPS.

9. The bolted joint according to claim 1, wherein said cover and said primary structure are made of a composite material.

10. The bolted joint according to claim 1, wherein said opening in the primary structure is an access opening of a fuel tank in a lower skin of a wing of an aircraft.

11. A lifting surface of an aircraft having an opening in a primary structure covered by a cover, wherein the cover and the primary structure are joined by a bolted joint according to claim 1.

12. Lifting surface according to claim 11, wherein said opening in a primary structure is the access opening of a fuel tank in the lower skin of a wing.

13. The bolted joint according to claim 2, wherein each second bolted joint comprises one of the bolts with a bushing fixed to it, the bushing having a length which is the same as a thickness of the cover, and the hole in the cover and the bushing are configured with a linear clearance between them in the direction of said symmetry axis.

14. The bolted joint according to claim 13, wherein each third bolted joint comprises one of the bolts with a bushing fixed to it, the bushing having a length which is the same as a thickness of the cover, and the hole in the cover and the bushing are configured with a radial clearance between them.
